(19) United States
(12) Patent Application Publication
(10) Pub. No.: US 2013/0304579 A1
(43) Pub. Date: Nov. 14, 2013

(54) COMMUNICATION METHOD

(71) Applicant: Rafaqat Mirza, Essex (GB)

(72) Inventor: Rafaqat Mirza, Essex (GB)

(21) Appl. No.: 13/467,716

(22) Filed: May 9, 2012

(51) Int. Cl. G06Q 40/00; G06Q 30/00; G06Q 30/02

(52) U.S. Cl. 705/14.55; 705/39; 705/26.41

(57) ABSTRACT

A method of facilitating contact between a first user and a second user. The method includes receiving an indication of interest from said first user, providing the indication of interest and a contact price to a second user, facilitating contact between the first user and the second user and facilitating payment of at least some of the contact price by the second user to the first user.

### BACKGROUND

The present invention is concerned with methods and systems for facilitating contact between a first person and a second person.

### SUMMARY

Improving communications technology has rapidly increased the ease with which people separated by large distances can communicate with one another. For example, telegraph, the telephone, and now the Internet have each improved the speed and ease with which people on one side of the world can communicate with people on the other side of the world.

In addition to overcoming the barriers of distance, the Internet, and in particular social networking, have also increased the connectness of the world's population. That is, people who may never have met, or may never meet, can nonetheless now communicate with each other. The popular theory of Six Degrees of Separation suggests that every person in the world is connected with every other person in the world by an average of six connections. Using social networking websites, one person is often able to view the networks of friends, or their friends' friends and so on, thereby facilitating communication between people without a direct connection. Indeed, it has been suggested that for users of Internet based social networking tools, the average degree of separation is now considerably less than six.

In general, however, most of a person's day to day business is conducted with other people with whom they have a direct connection, and even Internet based social networking tools require some degree of connection. The benefits for those who work to expand their social networks is well documented. As a person's network expands, the number of people with whom that person can do business increases. As such, those who excel at expanding their network, or “networking”, are often exposed to more opportunities than those who are not.

Expanding one's personal networks is, however, a relatively slow and sometimes difficult process. Given the benefits that come with an ability to communicate with a wider range of people, new methods of expanding personal networks, and facilitating communication are required.

In addition to personal connections, companies regularly wish to communicate with a large audience of people who have no direct link with that company. When advertising products or services, companies are trying to communicate a message to an audience some of whom will not have transacted any business with that company. This is especially true for new companies. As such, many companies use a scatter gun approach. Companies pay money to advertisement publishers to place adverts where it is hoped as many people as possible will see them, in the hope that some of those people would be interested in the product. For example, companies may pay the owners of billboards, television stations, magazines or websites.

To improve the conversion rate of advertising (that is, the number of people who, having seen an advert, proceed to purchase the advertised product or service), companies will often try to more directly target people they believe might be interested in the product or service. For example, choosing specific magazines, placing adverts between particular television programs, etc, where the consumer demographic is considered to be more likely than the general public to have an interest in an advertised product. However, while such methods are more targeted than general adverts, there is no guarantee that the people who see the advert will have any interest in the advertised product or service.

Advertising models facilitated by the Internet have, to some extent, improved the ability of a company to pay only for adverts directed to consumers interested in their products. For example, with “pay-per-click” advertising, a company pays each time a person clicks on one of their adverts. In this way, there is some measure of certainty that an advert “click” represents interest in the product being advertised. Even with pay-per-click, however, there is no guarantee that the consumer is actually interested in purchasing the advertised product or service. For example, a “click” may simply be the result of research into a product, and not imply any intention to purchase.

It is an object of some embodiments of the present invention to obviate or mitigate one or more of the problems outlined above.

According to a first aspect of the present invention, there is provided a method of facilitating contact between a first user and a second user, comprising: receiving an indication of interest from the first user; providing the indication of interest and a contact price to a second user; facilitating contact between the first user and the second user; and facilitating payment of at least some of the contact price by the second user to the first user.

In this way, the second user is provided with an indication of interest which originates with the first user, allowing the second user to be confident that the first user will be receptive to contact with the second user. Additionally, the first user can be paid by the second user for the contact with the second user.

Facilitating contact between the first user and the second user may comprise receiving a message from the second user and providing the message to the first user. The message may be in any form. For example, the message may comprise text, images, audio or video.

The facilitating payment may be dependent upon receiving an indication that the message has been viewed or listened to by the first user. That is, it may be that facilitating payment does not occur until an indication that the message has been viewed or listened to by the first user is received. For example, if the message is a textual message, the facilitation of payment may not occur until the user has read the message. In this way, it can be ensured that the contact price is only paid for messages which are viewed.

The at least some of the contact price may comprise all of the contact price.

The message may be an advert associated with the indication of interest. In this way, users can advertise their products or services to other users.

Facilitating contact may be dependent upon receiving an indication that payment of at least some of the contact price has been received by the first user. In this way, the first user is not contacted by the second user until the second user has paid at least some of the contact price.

The indication of interest may comprise an indication of intention to purchase a product or service.

Facilitating payment of at least some of the contact price by the second user to the first user may comprise receiving payment of the contact price by the first user and providing payment of at least some of the contact price to the second user.

The contact price provided to the second user may be received from the first user. For example, the first user may set a contact price, and the contact price set by the first user may be provided to the second user. In this way the first user can determine a price that must be paid to contact the first user.

Receiving an indication of interest may comprise receiving a plurality of indications of interest and receiving a respective contact price for each one of the plurality of indications of interest. Providing the indication of interest and the contact price to the second user may comprise providing one of the plurality of indications of interest and respective contact prices to the second user.

The method may further comprise receiving a search query from the second user, the search query indicating data associated with the first user. Providing the indication of interest to the second user may be in response to receiving the search query.

The method may further comprise providing the second user with a rank indication, the rank indication indicating a rank that will be associated with the message provided to the first user upon payment of the contact price by the second user. The second user may be provided with a plurality of rank indications, each rank indication indicating a rank that will be associated with the message provided to the first user upon payment of respective amounts by the second user. In this way, the second user is provided with an indication of how highly ranked their message to the first user will be. The second user can therefore decide whether to pay more than the contact price in order that their message to the first user be more highly ranked.

The method may further comprise receiving from a fourth user a bounty price and identification information for a fifth user; providing the bounty price and identification information to a sixth user; receiving an introduction to the fifth user from the sixth user; facilitating payment of at least some of the bounty price by the fifth user to the sixth user; and facilitating contact between the fourth user and the fifth user.

Facilitating contact between the fourth user and the fifth user may comprise receiving a message from the fourth user and providing the message to the fifth user.

Facilitating payment may be dependent upon receiving an indication that the message has been viewed or listened to by the fifth user.

According to a second aspect of the present invention, there is provided a method of facilitating contact between a first user and a second user, comprising: receiving a bounty price and identification information for a second user from the first user; providing the bounty price and identification information to a third user; receiving an introduction to the second user from the third user; facilitating contact between the first user and the second user; and facilitating payment of at least some of the bounty price by the first user to the third user.

It will be appreciated that aspects of the present invention can be implemented in any convenient way including by way of suitable hardware and/or software. Alternatively, a programmable device may be programmed to implement embodiments of the invention. The invention therefore also provides suitable computer programs for implementing aspects of the invention. Such computer programs can be carried on suitable carrier media including tangible carrier media (e.g. hard disks, CD ROMs and so on) and intangible carrier media such as communications signals.

It will also be appreciated that features presented in the context of one aspect of the invention in the preceding and following description can equally be applied to other aspects of the invention.

In general terms, the present invention is concerned with facilitating communication. Previously, it has generally been necessary for two people to share a connection (for example a direct connection, or a connection through one or more other people) in order for those two people to communicate with each other. Embodiments of the present invention facilitate direct communication between any two people, without a pre-existing connection between those two people.

### BRIEF DESCRIPTION OF THE DRAWINGS

FIG. 1 is a schematic view of a web server and users connected to the internet.

FIG. 2 is a schematic view of the web server.

FIG. 3a is first example of a user profile.

FIG. 3b is a second example of a user profile.

FIG. 4 is a schematic of a first advertising model.

FIG. 5 is a schematic of a second advertising model.

FIG. 6 is a schematic of a relationship between a connection exchange and a personal network.

FIG. 7 is a diagram illustrating one possible process carried out by the relationship shown in schematic in FIG. 6.

### DETAILED DESCRIPTION

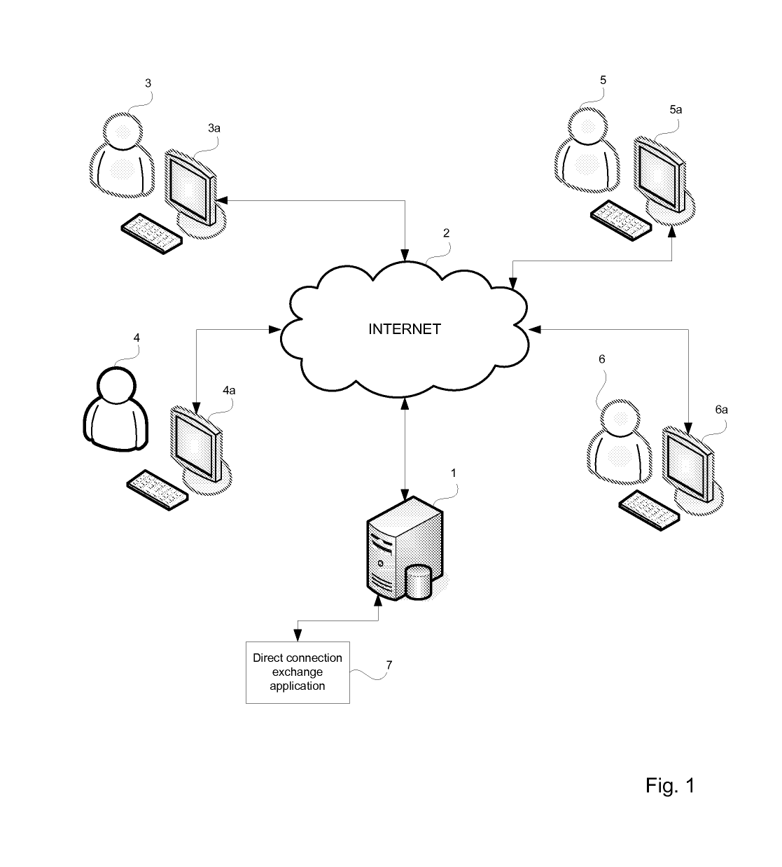

Referring to FIG. 1, a web server 1 is connected to the Internet 2. The web server 1 is configured to provide access to web pages over the Internet 2. Users 3, 4, 5, 6 can access web pages provided by the web server 1 via the Internet 2 using respective clients 3a, 4a, 5a, 6a. The clients 3a to 6a may be any appropriate computing device provided with means for connection to the Internet 2. For example, the clients 3a to 6a may be desktop or laptop computers, or Internet enabled mobile telephones.

The clients 3a to 6a are configured to use a web browser to display information provided by the web server 1 and to receive as input, information which is to be sent to the web server 1.

The web server 1 provides access to an application providing a direct connection exchange 7. The application providing the direct connection exchange 7 may be provided and run on the web server 1, or may, as will be readily appreciated by those skilled in the art, be provided by a separate application server (not shown), connected to the web server 1. The direct connection exchange 7 provides user interface elements within web pages, and the user interface elements are displayed to users via the web browser running on the respective clients 3a to 6a. In this way, the users 3 to 6 can remotely access the direct connection exchange 7 via the Internet 2. As will be readily appreciated by those skilled in the art, the arrangement of FIG. 1 is merely exemplary, and any configuration of computing and network devices, arranged to provide applications over the Internet may be used. It will further be appreciated that while four users 3 to 6 are shown in FIG. 1, in general any number of users can access the web server 1.

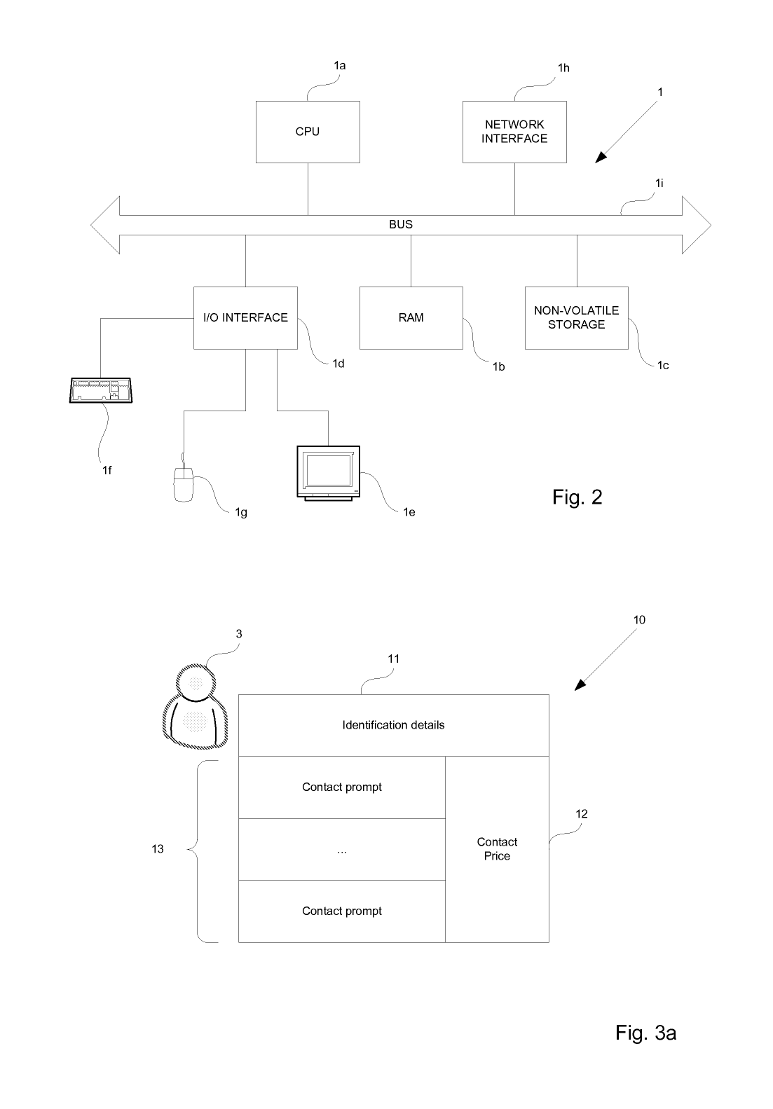

Referring to FIG. 2 there is shown a schematic illustration of components of the web server 1, which can be used to implement embodiments of the present invention. The clients 3a to 6a may be similarly arranged. It will be appreciated that the components of the web server 1 illustrated in FIG. 2 and described below are merely exemplary, and that any suitable electronic device may be used to implement embodiments of the present invention. It can be seen that the web server 1 comprises a CPU la which is configured to read and execute instructions stored in a volatile memory 1 b which takes the form of a random access memory. The volatile memory 1 b stores instructions for execution by the CPU 1a and data used by those instructions.

The web server 1 further comprises non-volatile storage 1c, for example in the form of a hard disc drive or a solid state drive. The web server 1 further comprises an I/O interface 1d to which are connected peripheral devices used in connection with the web server 1. More particularly, a display 1e is configured so as to display output from the web server 1. Input devices are also connected to the I/O interface 1d. Such input devices include a keyboard 1f and a mouse 1g which allow user interaction with the web server 1. A network interface 1h allows the web server 1 to be connected to an appropriate computer network (e.g. the Internet 2) so as to receive and transmit data from and to other computing devices (such as the clients 3a to 6a). The CPU 1a, volatile memory 1b, hard disc drive 1c, I/O interface 1d, and network interface 1h, are connected together by a bus 1i

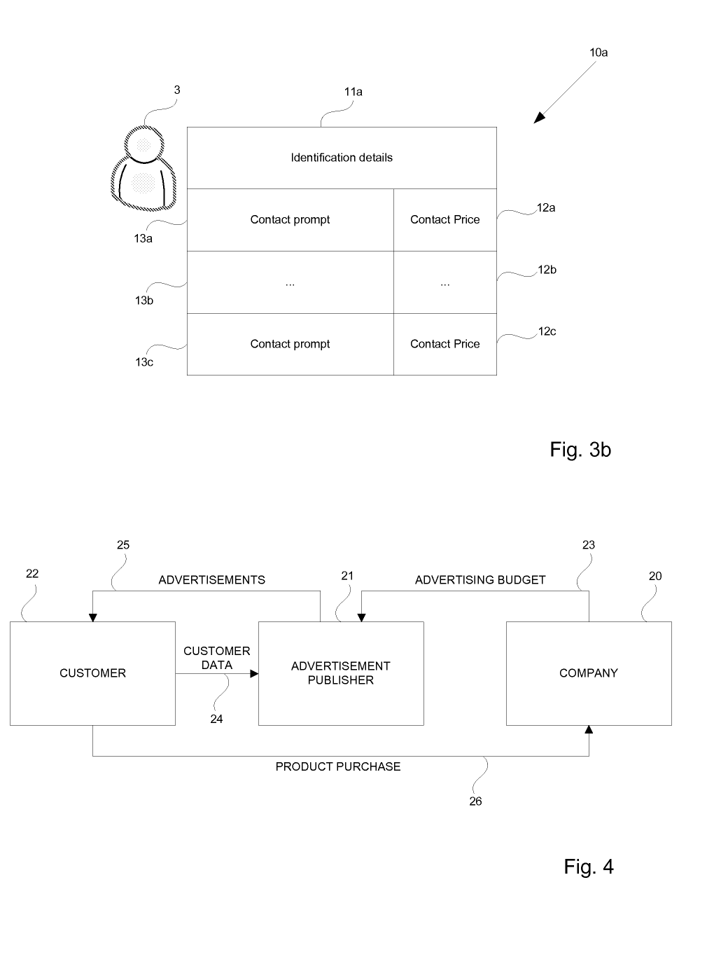

In general terms, the direct connection exchange 7 allows any one of the users 3 to 6 to initiate communication with any other ones of the users 3 to 6. In more detail, each of the users 3 to 6 of the direct connection exchange 7, first registers an account with the direct connection exchange 7. During a registration process, each of the users 3 to 6 creates a profile comprising personal details which are stored (for example on the non-volatile storage 1c) for use by the direct connection exchange 7 and others of the users 3 to 6. In particular, with reference to FIG. 3a and the user 3, during the registration process, the user 3 creates a user profile 10. The user profile 10 provides identification details 11 sufficient for the user 3 to be uniquely identified. For example, the identification details may comprise the name, address, bank details, etc of the user 3. The user profile 10 further comprises a “contact price” 12 set by the user 3. The contact price specifies a minimum payment to be made, to the user 3, by other users 4 to 6 in order to send a message to the user 3. For example, the user 3 may specify a contact price of $20 USD. Any one of the users 4 to 6 may then send a message to the user 3 by paying at least $20 USD to the user 3.

The user profile 10, further comprises one or more items of “contact prompt information” 13. The contact prompt information 13 is any information that the user 3 wishes to provide which might prompt messages from others of the users 4 to 6. For example, the user 3 may specify a plurality of upcoming purchases of products or services that he is intending to make. If, for example, the user 5 provides at least one of those products or services, the user 5 may wish to send a message the user 3 to advertise his ability to provide the desired products or services. In this way, the direct connection exchange 7 can be used as a means for businesses to direct advertising of products directly to customers who express an interest in those products. Once his profile is created, the user 3 will be able to add, or remove, contact prompt information, such as intended purchases, as products and services are bought and no longer required, and as new purchase intentions arise, and to change his contact price 12. The direct connection exchange 7 may provide prompts and templates for a user to populate their profile with their purchase intentions and other information concerning their interests, likes and dislikes, etc.

In some embodiments of the present invention, a user may specify different contact prices for different pieces of contact prompt information. For example, with reference to FIG. 3b, the user 3 may create a user profile 10a, which comprises a respective contact price 12a, 12b, 12c for each contact prompt 13a, 13b, 13c. For example, the user 3 may specify a contact price of $10 to receive messages in association with a contact prompt indicating an intended purchase of a plane ticket, while setting a contact price of $100 in association with a contact prompt indicating an intended property sale requiring services of a real estate agent. In this way, a user can tailor their contact price depending on the value of the purchase that they are intending to make to encourage other users to meet their contact price.

In some embodiments of the present invention, some or all of the contact price(s) 12, 12a-c are set by the direct connection exchange 7, rather than by the user 3. For example, the user 3 may be provided with a choice as to whether they wish to choose their own contact prices, or whether they would prefer the direct connection exchange 7 to determine their contact prices. Alternatively, the direct connection exchange 7 may not allow users to set their own contact prices. Where the direct connection exchange 7 sets contact prices, the contact prices may be fixed contact prices 12, 12a-c, or may be variable contact prices which are updated in response to any of a number of factors. For example, the contact price 12, 12a-c may be updated by the direct connection exchange 7 in response to a number of users searching the connection exchange 7 for particular contact prompt terms, or based upon a number of users of the connection exchange 7 who have been willing to pay a particular contact price over a previous period of time. The contact prices may be varied by the connection exchange 7 in response to any of a number of other factors which will now be readily apparent to the skilled person.

FIG. 4 schematically illustrates a simplified example of the flow of both information and money in a standard advertising model involving a company 20, an advertisement publisher 21 and a customer 22. The company 20 has an advertisement budget to attract customers to purchase the products and/or services of the company 20. The company 20 pays a portion of that advertisement budget to the advertisement publisher 21 to distribute adverts to the customer 22 (as denoted by an arrow 23 from the company 20 to the advertisement publisher 21). The advertisement publisher 21 may be, for example, a television broadcaster, a print publication, or a website. The advertisement publisher 21 collects information about the customer 22 (denoted by an arrow 24 from the customer 22 to the advertisement publisher 21) in order to more accurately target the advertisements to the interests of the customer 22. For example, a print publication may issue questionnaires to their readers in order determine demographic information about those readers, a television broadcaster may collect information about people who watch particular shows, etc. A website may encourage, or require, customers to enter personal information in order to use the website's facilities.

The customer data is used by the advertisement publisher 21 in providing advertisements to the customer 22 (as denoted by an arrow 25 from the advertisement publisher 21 to the customer 22). The customer 22 purchases products from the company 20 (denoted by an arrow 27) providing the company 20 with revenue. Depending on the advertisement publisher 21 and the nature of the adverts provided to the customer 22, the company 20 may, or may not, be able to determine whether any purchase by the customer 22 is a direct result of an advert supplied to the customer 22 by the advertisement publisher 21.

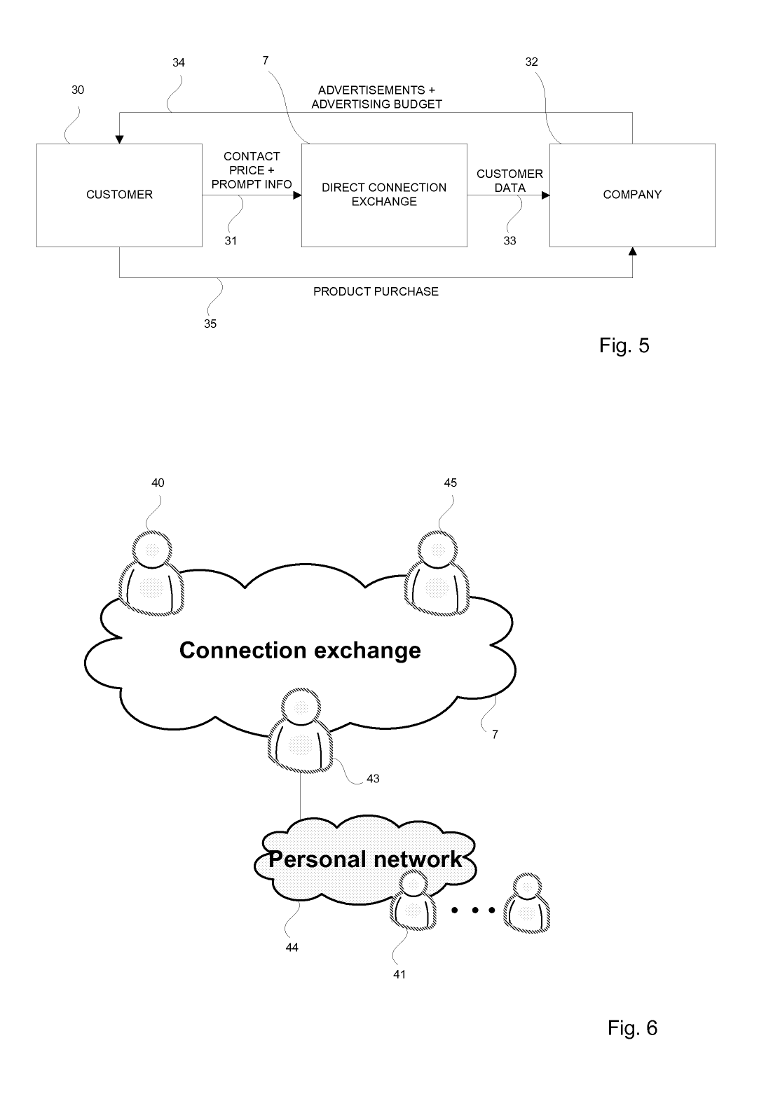

It will be appreciated that, in the arrangement of FIG. 4, information flows from the customer to the advertisement publisher 21, while money flows from the company 20 to the advertisement publisher 21, and from the customer 22 to the company 20. Money does not, in the arrangement of FIG. 4, flow to the customer 22. FIG. 5 schematically illustrates flows of information and money according to some embodiments of the present invention.

In the arrangement of FIG. 5, a customer 30, who is a user of the direct connection exchange 7, provides information about products or services that they wish to purchase, together with one or more contact prices, to the direct connection exchange 7, as described above (indicated by an arrow 31 from the customer 30 to the direct connection exchange 7). For example, the customer 30 indicates a desire to purchase a television, and specifies a contact price of $20. A company 32, who is also a user of the direct connection exchange 7, searches the direct connection exchange 7 for users that have specified that they wish to purchase televisions. The search results presented to the company 32 (as indicated by an arrow 33 from the direct connection exchange 7 to the company 32) indicate those users, including the customer 30, who have specified a desire to purchase a television, together with the contact prices set by those users. In some embodiments of the present invention, the search results comprise an indication of the number of users that have specified a desire to purchase a television, without personal details of those users being presented to the company 32. In this case, the company 32 can decide which users to contact based upon contact prices set by those users. Messages may be sent by the company 32 to the direct connection exchange 7, and sent in turn, from the direct connection exchange 7 to the customer 30.

Having received the search results, the company 32 can decide whether to pay the contact price of the customer 30. If the company 32 wishes to send a message to the customer 30, the company 32 pays at least the contact price to the customer 30 and sends a message advertising the company 32 (indicated by an arrow 34 from the company 32 to the customer 30). Messages sent from one user to another user may take any form. For example, messages may comprise written messages, audio messages, or multimedia messages. In some embodiments of the present invention, the company 32 pays the contact price set by the customer 30 only after the customer 30 has viewed the message sent by the company 32. That is, in some embodiments, the company 32 sends a message to the customer 30 through the direct connection exchange 7. The customer 30 then decides whether to view that message in order to receive payment of the contact price associated with that message. Upon detecting that the message has been viewed by the customer 30, the direct connection exchange 7 facilitates payment of the contact price by the company 32 to the customer 30.

Messages received by the customer 30 may be ranked according to an amount paid by the user from whom those messages originate. That is, while the contact price is a minimum price payable to contact the customer 30, the company 32 may wish to pay more than the contact price in order to have their messages ranked above users who contact the customer 30. The direct connection exchange 7 may provide an indication to the company 32 as to how messages will be ranked upon payment of a particular amount, based upon the customer 30's “unread” messages or messages due for transmission to the customer 30. For example, where one user has paid (or agreed to pay) more than contact price to send a message to the customer 30, and the customer 30 has not yet read that message, the search results presented to the company 32 may indicate that paying only the contact price will result in a message from the company 32 being ranked 2^{nd}. The search results may also indicate an amount that the company 32 would need to pay (or agree to pay) in order to be ranked 1^{st}.

Messages may be ranked or highlighted in any appropriate way. For example, messages from some users may be unavailable for viewing until the messages of each user who has paid more have been viewed. Alternatively, messages of those who have paid more to contact a user may be delivered before (for example, a day before) messages from those who have contributed less. Other methods to rank messages will be readily apparent to the skilled person.

Based on the advert 34 and payment of the contact price, the customer 30 may purchase a television from the company 32 (indicated by an arrow 35 from the customer 30 to the company 32). In the arrangement of FIG. 5, therefore, the customer 30 provides information about his intended purchases to the company 32 via the direct connection exchange 7, thereby bypassing the advertisement publisher 21. As the customer information is provided directly by the customer 30, the company 32 knows that the customer 30 is actually interested in purchasing the advertised products or services. The conversion rate of the advert 34 is, therefore, likely to be higher than that of the advert 25 of FIG. 4. Further, given that the company 32 knows, from the information 33, that the customer 30 wishes to purchase a television, any subsequent purchase of a television from the company 32 by the customer 30 following the advertisement 34, is a strong indication of success of the advertisement 34. In addition, by directing a portion of its advertising budget to the customer 30, the company 32 is providing an additional incentive for the customer 30 to conduct business with the company 32 rather than with companies who direct their advertising budget to a third party.

While the contact price is shown, by arrow 34, as being paid directly from the company 32 to the customer 30, the payment of the contact price may be facilitated by the direct connection exchange 7. That is, the company 32 may pay the contact price to the direct connection exchange 7, which may in turn pay the customer 30. In some embodiments of the invention, the direct connection exchange 7 may receive a portion of the contact price paid by the company 32. For example, the connection exchange 7 may receive 20% of the contact price, while paying the customer 30 80% of the contact price. Where the direct contact exchange 7 receives some of the contact price paid by the company 32, the contact price displayed to the company 32 may be higher than that set by the customer 30, so that, for example, the customer 30 receives the full amount of the contact price that they set.

It will be appreciated that contact prompt information other than intended purchases, can be provided. For example, clubs may wish to message members of the connection exchange 7 based on contact prompt information relating to interests

Embodiments of the present invention also facilitate connection with people who are not currently registered with the direct connection exchange. Referring to FIG. 6, a person 40, who is a member of the direct connection exchange 7, wishes to transmit a message to a person 41, who is not a member of the connection exchange 7, such that the person 40 cannot transmit a message using the direct connection exchange 7, (i.e. by paying a contact price set by the person 41, as described above). In order to communicate with the person 41, therefore, the person 40 places a “bounty” on the person 41. The bounty is a value that the person 40 is willing to pay to a third party to persuade the person 41 to join the connection exchange 7 and read a message from the person 40.

The bounty specifies sufficient details to allow the user 41 to be identified by third parties. It will be appreciated that what constitutes sufficient details will vary depending upon the person on whom the bounty is placed. For example, a person looking to transmit a message to the Hollywood actor Tom Cruise would need to supply relatively few details to ensure that people seeking to claim the bounty would be able to identify the correct Tom Cruise. For people who are less well-known, however, a bounty would generally require more detail in order to ensure that the correct person could be identified by those seeking to claim the bounty. The bounty information is then made available to members of the connection exchange 7 so that those members can attempt to claim the bounty by persuading the targeted person to join the connection exchange 7. The bounty may be advertised directly to some or all of the members of the connection exchange 7, or may simply be available for searching by the members.

Referring again to FIG. 5, a person 43 is a member of the connection exchange 7 and knows the person 41 through a personal network 44. The person 43 may therefore encourage the person 41 to join the connection exchange 7 in order to collect the bounty from the person 40.

Another person 45, also a member of the connection exchange 7, may also wish to send a message to the person 41. The person 45 may, therefore, add to the bounty on the person 41, thereby increasing the incentive to, and the likelihood that, third parties will attempt to enlisted the user 41. Upon the user 41 joining the connection exchange 7, the bounty is paid by the users 40 and 45 and paid to the user 43. Alternatively, the bounty may be split between the user 43 and the person 41 according to a predetermined, or an agreed ratio.

The messages of the users 40 and 45 are then delivered to the person 41. Delivered messages may be ranked according to the respective bounty contribution of the user from whom the message is sent. Ranking may be performed in any appropriate way as described above with reference to FIG. 5. For example, if the user 40 contributed $100 to the bounty, and the user 45 contributed $200, the message from the user 45 would be ranked more highly, or highlighted in another way. Subsequent messages to the person 41 from members of the connection exchange 7 are made directly, paying a contact price set by the user 41 as described above.

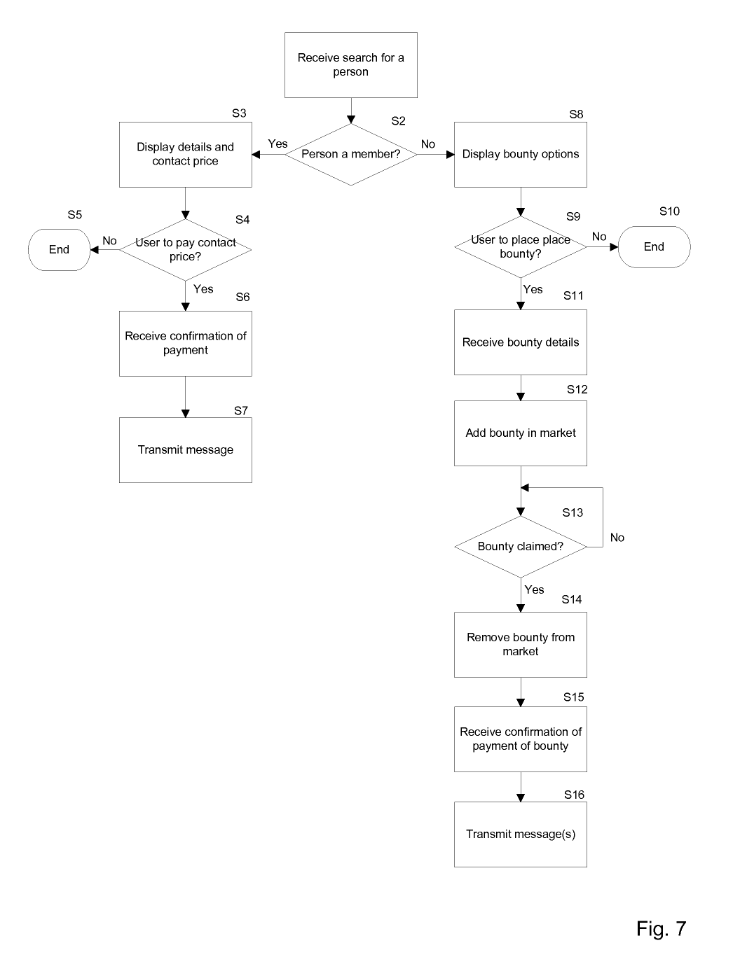

With reference to FIG. 6 and FIG. 7, there is now described processing carried out by the application 7 to transmit a message from a user to another person. At a step S1, the application 7 receives a search request from the user 4, for a person to whom the user 4 wishes to send a message. Processing passes to a step S2 at which it is determined whether the sought person is a member of the connection exchange 7. If it is determined that the sought person is a member of the connection exchange 7, for example the user 5, processing passes to step S3, at which the user 5's details and contact price are displayed to the user 4, together with an option to pay the contact price and to send a message to the user 5.

Processing passes from step S3 to a step S4, at which it is determined whether the user 4 wishes to pay the contact price to send a message to the user 5. If it is determined that the user 4 does not wish to pay the contact price set by the user 5, processing ends at step S5. If, on the other hand, it is determined at step S4 that the user 4 does wish to pay the contact price set by the user 5, processing passes to a step S6, at which the application 7 receives confirmation of payment from the user 4 to the user 5. For example, in some embodiments of the invention, payment may be processed directly by the connection exchange 7 such that confirmation is achieved upon successful execution of the transaction. In other embodiments, payment may be arranged externally to the connection exchange 7, and confirmation may require confirmation by the user 5 that payment has been received. Upon receipt of confirmation of payment, processing passes to a step S7, at which a message from the user 4 is transmitted to the user 5.

If, at step S2, it is determined that the received search relates to a person not currently a member of the connection exchange, processing passes to a step S8, at which the user 4 is presented with the option to place a bounty on the person they wish to message. Processing passes from step S8 to a step S9, at which it is determined whether the user 4 wishes to place a bounty on the sought person. If it is determined that the user 4 does not wish to place a bounty on the sought person, processing ends at a step S10. If, on the other hand, it is determined that the user 4 does wish to place a bounty on the sought person, processing passes to a step S11, at which the application receives the details of the bounty from the user 4.

Processing passes from step S11 to a step S12, at which the bounty information is made available to members of the connection exchange 7. As described above, making the bounty available to members of the connection exchange 7 may comprise directly advertising the bounty to one or more members of the connection exchange. Processing passes from step S12 to a step S13, at which it is determined whether the bounty has been claimed. If it is determined that the bounty has not been claimed, processing remains at step S12 until, upon determination that the bounty has been claimed (i.e. the sought person has joined the connection exchange upon the recommendation of a third party member), processing passes to a step S14 at which the bounty is removed from the market. Processing then passes to a step S15 at which confirmation of payment of the bounty to the third party member is received. Processing passes from step S15 to step S16 at which a message is transmitted from the user 4 to the sought person.

The direct connection exchange 7 may be funded in a number of ways. For example, the direct connection exchange 7 may require a subscription payment to be paid by members. Alternatively or additionally, the direct connection exchange 7 may retain a portion of transactions between members (e.g. the payment of contact prices and bounties) that are conducted through the direct connection exchange 7. It will be appreciated that any other appropriate means of funding may be employed.

Embodiments of the present invention have been described above and it will be appreciated that the embodiments described are in no way limiting. Indeed, many variations to the described embodiments will be apparent to an ordinary skilled person, and such variations are within the spirit and the scope of the present invention.

1. A computer-implemented method of facilitating contact between a first user and a second user, comprising:
receiving an indication of interest from said first user;
providing said indication of interest and a contact price to a second user;
facilitating contact between said first user and said second user; and
facilitating payment of at least some of said contact price by said second user to said first user,
wherein facilitating contact between said first user and said second user includes receiving an advertisement message associated with said indication of interest from said second user and providing said advertisement message to said first user.

2. (canceled)

3. A method according to claim 1, wherein said facilitating payment is dependent upon receiving an indication that said message has been viewed or listened to by said first user.

4. (canceled)

5. A method according to claim 1, wherein said facilitating contact is dependent upon receiving an indication that payment of at least some of said contact price has been received by said first user.

6. A method according to claim 1, wherein said indication of interest comprises an indication of intention to purchase a product or service.

7. A method according to claim 1, wherein at least some of said contact price comprises all of said contact price.

8. A method according to claim 1, wherein the facilitating payment of at least some of said contact price by said second user to said first user comprises receiving payment of said contact price by said second user and providing payment of at least some of said contact price to said first user.

9. A method according to claim 1, wherein said contact price provided to said second user is received from said first user.

10. A method according to claim 1, wherein said indication of interest is one of a plurality of indications of interest received from the first user, each indication of interest having a respective contact price; and
wherein providing said indication of interest and said contact price to said second user comprises providing one of said plurality of indications of interest and respective contact prices to said second user.

11. A method according to claim 1, further comprising:
receiving a search query from said second user, said search query indicating data associated with said first user;
and wherein providing said indication of interest to the second user is in response to receiving said search query.

12. A method according to claim 1, further comprising:
providing said second user with a rank indication, said rank indication indicating a rank that will be associated with said message provided to said first user upon payment of the contact price by said second user.

13. A method according to claim 1, further comprising:
providing said second user with a plurality of rank indications, each of the rank indications indicating a rank that will be associated with said message provided to said first user upon payment of a respective amount by said second user.

14. A method according to claim 1, further comprising:
receiving from a fourth user a bounty price and identification information for a fifth user;
providing said bounty price and identification information to a sixth user;
receiving an introduction to said fifth user from said sixth user;
facilitating payment of at least some of said bounty price by said fifth user to said sixth user; and
facilitating contact between said fourth user and said fifth user.

15. A method according to claim 14, wherein facilitating contact between said fourth user and said fifth user comprises:
receiving a message from said fourth user and providing said message to said fifth user.

16. A method according to claim 15, wherein facilitating payment is dependent upon receiving an indication that said message has been viewed or listened to by said fifth user.

17. An apparatus for facilitating contact between a first user and a second user, comprising:
a first receiver configured to receive an indication of interest from said first user;
an output configured to output said indication of interest and a contact price to a second user;
contact means configured to facilitate contact between said first user and said second user; and
a payment facilitator to facilitate payment of at least some of said contact price by said second user to said first user.

18. A non-transitory computer readable medium carrying computer program code comprising computer readable instructions configured to cause a computer to carry out a method according to claim 1.

19. A computer apparatus for facilitating contact between a first user and a second user, comprising:
a memory storing processor readable instructions; and
a processor arranged to read and execute instructions stored in said memory;
wherein said processor readable instructions comprise instructions arranged to control the computer to carry out a method according to claim 1.

20. A computer-implemented method of facilitating contact between a first user and a second user, comprising:
providing a connection exchange application arranged to:
receive a bounty price and identification information for a second user from said first user, the second user being unknown to the connection exchange application;
provide said bounty price and identification information to a plurality of third users;
receive an introduction to said second user from one of said plurality of third users;
facilitate contact between said first user and said second user; and
facilitate payment of at least some of said bounty price by said first user to said one of said third users.

21. An apparatus for facilitating contact between a first user and a second user, comprising:
a first receiver configured to receive a bounty price from said first user;
an output configured to provide said bounty price to a third user;
a second receiver configured to receive an introduction to said second user from said third user;
contact means configured to facilitate contact between said first user and said second user; and
a payment facilitator configured to facilitate payment of at least some of said bounty price by said first user to said third user.

22. A non-transitory computer readable medium carrying computer program code comprising computer readable instructions configured to cause a computer to carry out a method according to claim 20.

23. A computer apparatus for facilitating contact between a first user and a second user, comprising:
a memory storing processor readable instructions; and
a processor arranged to read and execute instructions stored in said memory;
wherein said processor readable instructions comprise instructions arranged to control the computer to carry out a method according to claim 20.
